(19) United States
(12) Patent Application Publication
(10) Pub. No.: US 2016/0035231 A1
(43) Pub. Date: Feb. 4, 2016

(54) METHOD AND SYSTEM TO PROVIDE AN INTERACTIVE CINEMATIC READER FOR IMAGE DRIVEN PUBLICATIONS

(71) Applicant: Cornea Entertainment Pvt. Ltd., Bangalore (IN)

(72) Inventors: Rajath Mahabala Alva, Bangalore (IN); Sushanth Sreenivasamurthy Manakhari, Bangalore (IN)

(73) Assignee: CORNEA ENTERTAINMENT PVT. LTD., Bangalore (IN)

(21) Appl. No.: 14/801,328

(22) Filed: Jul. 16, 2015

(30) Foreign Application Priority Data
Jul. 31, 2014 (IN) 3742/CHE/2014

(51) Int. Cl. G09B 5/06; G06T 11/60; G06F 3/16; G06T 13/80; G06F 3/0484; G06F 3/0483

(52) U.S. Cl. CPC G09B 5/06; G06F 3/04842; G06F 3/0483; G06F 3/165; G06T 13/80; G06T 11/60

(57) ABSTRACT

A method and system for providing a movie experience while reading an e-book. The system includes a book/package server containing proprietary .cpub (cinematic publishing) files. The method includes creating a video with experiential entities of a movie by understanding and executing the .cpub files. This further includes integrating image galleries, multimedia presentations, videos, animated and static diagrams, charts and tables, visual dictionaries, from various comic books, graphic novels, and photo novels. The book/package server, which is associated with the system, stores various books along with Java program files. The Java program files make use of certain libraries for providing high end graphics or animations to a user. A user can either download or view a selected book by accessing the book/package server. Further, the system provides secure data sharing and authentication by generating unique keys while accessing the e-book.

### FIELD OF INVENTION

The present invention generally relates to digital publishing and entertainment and more particularly to provide an interactive Media reader/viewer for a user to get movie like experience while reading an image driven publication.

### BACKGROUND OF INVENTION

As a result of the digital era, more and more books are getting converted into an electronic format (also called e-books or digital books). E-books are becoming a new trend in the world of information technologies. E-books offer a wide range of interesting teaching and learning possibilities. Due to the space limitations faced by many libraries, e-books appear to be an efficient means to store and organize information. In the recent years, several systems were designed to improve user experience with these e-books.

The interactions between a user and e-book content are often limited to merely scrolling through text and viewing static content such as images. The existing e-book readers provide means for replacing paper pages with electronic screens and in some cases they replace the need for visual display by converting the visual text into audible sounds.

In another exemplary embodiment, a system for an electronic picture book is used. The embodiments include a plurality of pages graphically describing a story with a plurality of buttons. This further requires a user having a level of technical sophistication in addition to investing a substantial amount of time in learning to use the program. In another exemplary embodiment, a display for hand-held content display device explaining an electronic reading system is used. This system permits a person to download books from internet sites to a hand-held reader device. However, more and more books emerge in the market, and with rapid development of internet, secure access of the e-book is paid more attention. Due to the rapid spread and mass users of the internet, several problems are arising for accessing e-books or comic books securely from an online store.

In another exemplary embodiment, portable electronic reading apparatus discussed about an electronic book that employs an electronic field addressable which is rewritable and colorant. In other exemplary embodiment, a system for an electronic book discusss a method for calculating the reading speed and so on. Some other exemplary embodiments disclose certain features of the e-books like selectively varying the reading speed while reading the e-book. These above-mentioned references however, fail to provide a cinematic experience that combines pictures and text with animation and sound.

In light of the above, there appears to be a need in the art for an Interactive digital book or a Media player for providing a movie experience while reading an e-book or comic book. Accordingly, there is a further need for an Interactive Media application (for example, a reader or viewer) which comprises a plurality of options and that needs to provide a more cinematic immersive experience.

### OBJECT OF INVENTION

The principal object of the embodiments herein is to create an Interactive media player system having an interactive Media reader/viewer for providing a movie experience while reading a comic-book or form of animated book.

Another object of the invention is to create Programmed interactive animations with experiential entities of a movie by understanding and executing .cpub files.

Another object of the invention is to display animation to a user by executing the Java program files by integrating integrating image galleries, multimedia presentations, videos, animated and static diagrams, charts and tables, visual dictionaries, and so on from various animated books, Graphic novels, and Photo novels.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram depicting the components in an Interactive media reader/viewer system with an Interactive Media reader/viewer, according to embodiments as disclosed herein;

FIG. 2 is a more detailed block diagram illustrating various modules in the Interactive Media reader/viewer such as that of FIG. 1, according to the embodiments as disclosed herein;

FIG. 3 is a more detailed block diagram illustrating various modules in a Book/Package server such as that of FIG. 1, according to the embodiments as disclosed herein;

FIG. 4 is a flow diagram depicting a method for providing movie experience while reading an e-book by using the Interactive media reader/viewer system having the an Interactive Media reader/viewer, according to the embodiments as disclosed herein;

FIG. 5 is a flow diagram illustrating a method of User interaction associated with the Interactive media reader/viewer system, according to the embodiments as disclosed herein;

FIG. 6 is a block diagram which illustrates various key tagging mechanisms associated with the Interactive media reader/viewer system to secure data sharing and authentication, according to the embodiments as disclosed herein;

FIG. 7 depicts an exemplary block diagram illustrating User interaction with the Interactive media reader/viewer system while downloading an e-book or comic book, according to embodiments as disclosed herein;

FIG. 8 illustrates a computing environment implementing the Interactive media reader/viewer application, according to embodiments disclosed herein; and

FIG. 9 is a block diagram of a machine in the example form of a computer system 900 within which instructions for causing the machine to perform any one or more of the methodologies discussed herein may be executed.

### SUMMARY OF THE INVENTION

The inventive methodology is directed to methods and systems that substantially obviate one or more of the above and other problems associated with conventional techniques for electronic publishing.

In accordance with one aspect of the inventive concept, there is provided a method, a computer programming product and a computerized system. In accordance with this aspect of the inventive concept, published electronic content is represented in a relational database schema and stored in a relational database. The published electronic content is retrieved from the database using a software system interfacing with the relational database. After the retrieving, the retrieved published electronic content is displayed on a display media. The published electronic content is approved by the respective publisher thereof.

In accordance with another aspect of the inventive concept, there is provided a method, a computer programming product and a computerized system. An inventive system in accordance with this aspect of the inventive concept includes a plurality of federated database servers operable to provide horizontal view to all member servers of a catalogue of electronic material available for download onto an electronic reading system containing a database. The system is further operable to enable user groups to access the electronic material contained in the catalogue and, upon purchase, download the electronic material into at least one electronic reading system of at least one member of the user groups in a seamless manner.

In accordance with yet another aspect of the inventive concept, there is provided a method, a computer programming product and a computerized system for viewing a book in an electronic format on two physically separated electronic devices. A first device displays one page of the book at a time, while a second device displays multiple control menus and additional content associated with the page of the book displayed by the first device.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

Once the digital device receives the user input signal, which may be in the form of an image, video, graphics, text, or any other digital data form, the digital device may further process the image to enhance it, compress it, or otherwise modify it to make it compatible with the digital device's data requirements. The digital device's processed input data is then sent through shared connections to a system that supports internet services, TV broadcast services, gaming services, e-book services, in-home data net leading to a converged IP network solution where content and services provided by these services may be unified and synchronized to provide a converged interfaced data such that the user input is also merged.

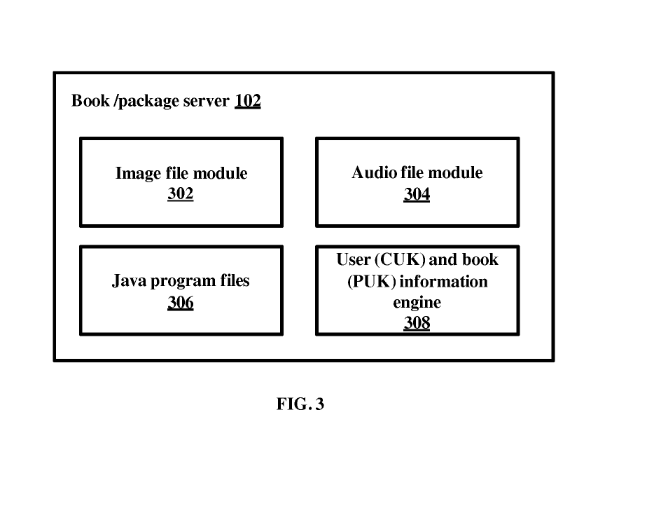

An application of this embodiment is to provide the user with the enhanced experience of viewing himself as part of a broadcast show which he may subsequently desire to record via the digital media recorder. Such a network system allows the digital device to transmit the user's request and data to a network where his request is processed and his data inserted per the instruction provided by the user into the video data that is to be broadcast. Referring now to FIG. 3 we show a user input 150 of a photo image of the user used to replace the face of the image shown on the device 108. The user transmits the photo image 150 by wired or wireless means to the device 108. The image substitution is performed and the device 108 shows the substituted image 190.

Another embodiment of this invention allows for a stand-alone digital device to receive input digital data from a user or from a wired or wireless imaging device for the purpose of creating a modified converged data stream processed by the input device such that said converged data stream is the result of the input device's original stream modified by the user inputted or imaging device inputted data. One application of this embodiment can be a gaming device where the user enters a video or image of him for its immersion into a game or graphics data stream that has been created by the imaging device. Said imaging device is capable of receiving the user's data wirelessly or through a camera or video device that may be part of the digital device.

The resulting converged data stream will then contain the user's image data in the game data. This will allow the user to become part of the game with his or her data image. The user's input data, which may be an image or video of himself, is added to a particular structure that is denoted by the user. The user inputted data will contain, in addition to the user image data, instructions to indicate which actor, avatar, or structure the user will like to have his data incorporated into. In this example, the resulting graphics or video game is one in which the viewer will see his image as part of the game.

The received digital data form is additionally formatted such that an instruction is conveyed in the message data to explain how and where the digital data is to be inserted into the converged interface data. This process requires the input device to perform video, image analysis and processing in order to recognize the actor or structure the user requests to have substituted by his inputted data. The process further requires the steps of background analysis, face detection and recognition, image and video motion detection and analysis to follow through the input device's motion sequence with the user's inputted data to produce a resulting stream where the user inputted data becomes part of the input device's stream as if it were originally its own.

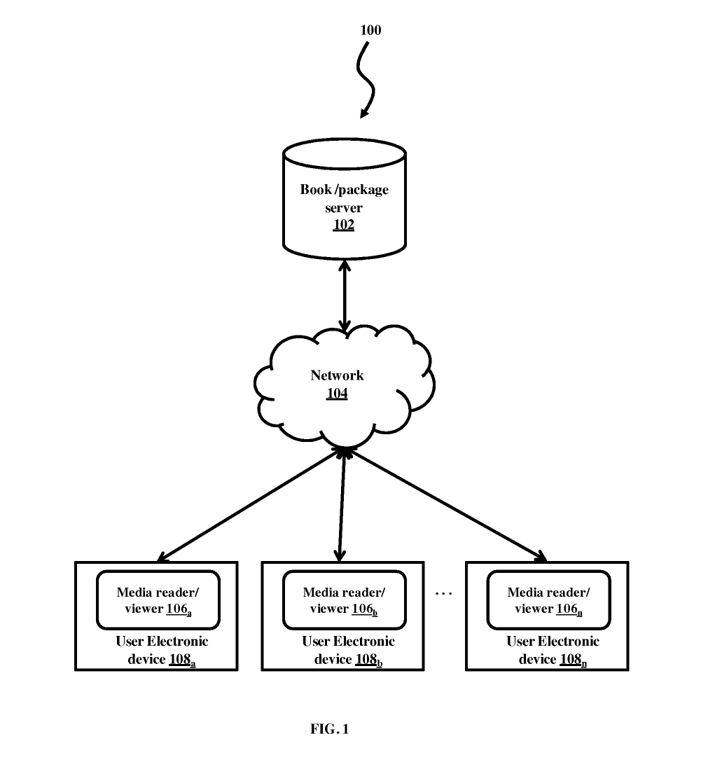

In another embodiment of this invention the user is capable of generating a set of programming instructions or widgets for the purpose of blending the user defined video with the metadata or internet content, whereby the internet network devices are capable of interpreting said set of instructions to produce a modified synchronized converged data stream. The programming instructions can be stored in a computer readable storage medium such as a CDROM or DVD-ROM, or other suitable media device. The user defined data that has been attached to the programming instructions is embedded in the original metadata to create the modified synchronized converged data stream. A PC, connected as shown in FIG. 1, may be used to produce the set of programming instructions and for attaching the user input data to the set of instructions. In the configuration where the stand alone devices are used independently of the internet content metadata, the PC transmits the user data and programming instructions directly to the stand-alone device configuration for further processing as described in the paragraph above.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method and system to provide movie experience while reading an e-book by using an Interactive Media reader/viewer. The system includes a Book/package server containing proprietary .cpub (cinematic publishing) files. The method includes integrating image galleries, multimedia presentations, videos, animated and static diagrams, charts and tables, visual dictionaries, and so on from various Comic books, Graphic novels, and Photo novels and further creates a video with experiential entities of a movie. The method includes creating a video with experiential entities of a movie by understanding and executing the .cpub files through the embedded file. Unlike the conventional systems, the proposed method and system comprises various elements such as Visual effects, Cinematic music, and Interactivity to provide the best movie experience while reading an e-book.

Referring now to the drawings, and more particularly to FIGS. 1 through 10, where similar reference characters denote corresponding features consistently throughout the figures, there are shown preferred embodiments.

FIG. 1 is a block diagram depicting the components in an Interactive media reader/viewer system with an Interactive Media reader/viewer, according to embodiments as disclosed herein. As depicted in FIG. 1, the Interactive media reader/viwer system 100 comprises of a Book/package server 102, Network 104, and one or more User electronic devices 108a to 108n (herein after referred as User electronic device 108). The User electronic device 108 further comprises a Media reader/viewer 106. In an embodiment, the Interactive media reader/viewer system 100 can also be run offline if the User has direct access to the Book/package server 102 through his/her User electronic device 108. The Interactive media reader/viewer system 100 can be deployed across various platforms including, but not limited to, Android, iOS, Windows, Kindle e-book readers, smart televisions and so on. The Book /package server 102 offers applications trough the network 104 by means of web sites in the World Wide Web.

The Media reader/viewer 106 allows the users to experience a movie like feel while reading an e-book by using the User electronic device 108. The Media reader/viewer 106 is a cross platform application which understands and executes .cpub files associated with the Book/package server 102. In an embodiment, the Interactive media reader/viewer system 100 generates a unique key for each user when the user installs the application for first time in the User electronic device 108. This key is called as Customer Unique Key (CUK).

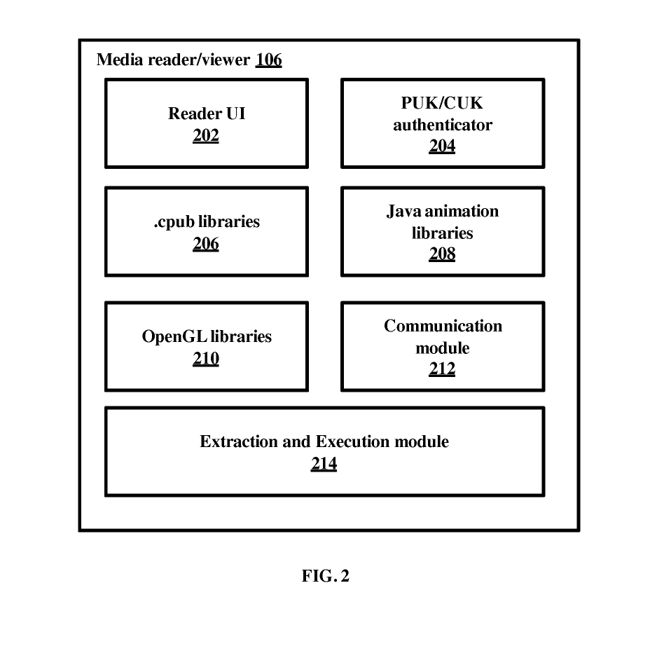

In an embodiment, the Interactive media reader/viewer system 100 generates a unique key called as Possat Unique Key (PUK) for each book that is uploaded in the Book/package server 102. The PUK is used for authenticating the accessibility of a book in the Book/package server 102. Additional details of the Media reader/viewer 106 and the Book/package sever 102 are given below, in connection with FIG. 2 and FIG. 3.

The Network 104 represents the communication pathways among the Book/package server 102, User electronic device 108, and any other entity connected to the Network 104. For example, the Media reader/viewer 106 communicates with the Book/package server 102 through the Network 104. In an embodiment, the Network 104 can be a wireless network, wire line network, public network such as the Internet, private network, General Packet Radio Network (GPRS), Local Area Network (LAN), Wide Area Network (WAN), Metropolitan Area Network (MAN), cellular network, Public Switched Telephone Network (PSTN), personal area network, and the like. For example, the network 106 can be operable with cellular networks, Wi-Fi networks, or any other networks or combination thereof.

The Network 104 can also utilize dedicated or private communications links that are not necessarily part of the Internet. In an embodiment, the Network 104 uses standard communications technologies and/or protocols such as Ethernet, 802.11, Integrated Services Digital Network (ISDN), Digital Subscriber Line (DSL), Asynchronous Transfer Mode (ATM), and so on. Similarly, the networking protocols used on the Network 106 can include Multiprotocol Label Switching (MPLS), the Transmission Control Protocol/Internet Protocol (TCP/IP), the Hypertext Transport Protocol (HTTP), the Simple Mail Transfer Protocol (SMTP), the File Transfer Protocol (FTP), the Short Message Service (SMS) protocol, and so on.

The data exchanged over the Network 104 can be represented using technologies and/or formats including the HTML, the Extensible Markup Language (XML), the Extensible Hypertext Markup Language (XHTML), the compact HTML (cHTML), and the like. In addition, all or some of links can be encrypted using conventional encryption technologies such as, but not limited to the Secure Sockets Layer (SSL), HTTP over SSL (HTTPS), and/or Virtual Private Networks (VPNs).

The User electronic device 108 may include a mobile computing device or any other portable device. For example, the User electronic device 108 stores program instructions that are executable to implement a browser program for displaying web pages (those hosted by Interactive Media reader/viewer system 100). A user of the User electronic device 108 may use a browser to select one or more video files stored at the Book/package server 102 for playback.

In an embodiment, the User electronic device 108 includes a mobile telephone, laptop, tablet, computing pad, net book and the like. The User electronic device 108 also includes relatively less portable devices such as, but not limited to, desktop personal computers, and tablet devices.

FIG. 2 is a more detailed block diagram illustrating various hardware modules in the Interactive Media reader/viewer 106 such as that of FIG. 1, according to the embodiments as disclosed herein. The Media reader/viewer 106 comprises a Reader User Interface (UI) 202, a PUK/CUK authenticator 204, a plurality of .cpub libraries 206, a plurality of Java animation libraries 208, a plurality of OpenGL libraries 210, a communication module 212, And an extraction and execution module 214.

In this block diagram of FIG. 2, as well as other diagrams and written descriptions elsewhere in the present patent applications, it will be understood that elements described in the abstract as the Reader User Interface (UI) 202, the PUK/CUK authenticator204, the plurality of .cpub libraries 206, the plurality of Java animation libraries 208, the plurality of OpenGL libraries 210, the communication module 212, and the extraction and execution module 214 may be implemented in hardware or software, as a general purpose computer system having software program code for implementing the functionality described herein through operation of the computer system as it executes the program software code.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

The Reader UI 202 resides on the Media reader/viewer 106 of the User electronic device 108 and serves web pages or suitable content to the User electronic device application. In an embodiment, the Reader UI 202 may be any suitable interface that facilitates communications between the user and the Media reader/viewer 106 within the system 100. In an embodiment, the Reader UI 202 allows the user to provide inputs to the system 100. For example, the user can provide the input details including but not limited to parameters such as login credentials, search strings and other related information and so on.

In an embodiment, the Reader UI 202 provides various user interactive elements such as scene menu grid, navigator, and so on. The files may include any suitable type of playable format. In one embodiment, each file is encoded using various suitable formats corresponding to different platforms. The scene menu grid associated with the Reader UI 202 is used to display the preview and link to multiple scenes in a clip. In an embodiment, a navigator can be associated with the User interface module 202 which is further used to let the users navigate between various points.

The PUK/CUK authenticator 204 is configured to authenticate the PUK and CUK embedded in the Book/package server 102. This can be done by using the communication module 212 before displaying the animation on the Reader UI in the User electronic device 106. In an embodiment, the PUK/CUK authenticator 204 also authenticates the login information provided by the user whenever the user is using the application. Authentication is the process of confirming the identity of a user. Authentication can include but not be limited to HTTP basic authentication, Form-based login authentication, client certificate authentication, mutual authentication and digest authentication. The Authentication module 204 verifies the login information by using the data associated with the Interactive Media reader/viewer system 100.

The Media reader/viewer 106 is a cross platform application which understands and executes .cpub files associated with the Book/package server 102. The various file libraries included in the Media reader/viewer 106 can be used to create several different types of publications. For example, Web site and e-mail formats contain text and both raster and vector graphics. In an embodiment, these libraries can have shared library files of the same format as the executable files. The Media reader/viewer 106 is configured to play the media files which are selected (either downloaded or for OTE) to play by using the Media player engine 106.

In an embodiment, the program files associated with the Media reader/viewer 106 make use of certain Book/package server libraries, in-built android libraries, open source animation libraries and open source openGL libraries 210 for high end animations and graphics.

The Extraction and execution module 214 is configured to extract and execute the data files that are included in the the Book/package server 102. In an embodiment, the Extraction and execution module 214 extracts various entities such as, but not limited to stop point information, Graphic Interchange Format (GIF) animated files, play buttons and so on from the Book/package server 102.

The Media reader/viewer 106 also includes a Memory module (not shown in FIG. 2) which is representative of any memory within or accessible to the Media reader/viewer 106. The Memory module stores the extracted entity data such as stop point information, GIF animated files, play buttons for a temporary duration and transfers them to an Integration module which is configured to integrate the GIF animated scenes into the scene menu grid with the experiential entities of a movie.

FIG. 3 is a more detailed block diagram illustrating various modules in a Book/package server such as that of FIG. 1, according to the embodiments as disclosed herein. The Book/package server comprises a Image file module 302, an Audio file module 304, a plurality of Java program files 304 and a User (CUK) and book (PUK) information engine 308. The book /package server 102 is a high bandwidth server which contains information about that runs on the Media reader/viewer 106. The book/package server 102 includes a file containing proprietary file extension .cpub (cinematic publishing). The Image file module 302 contains images in the file formats such as, but not limited to, PNG, JPEG, GIF, TIF, and SVG, and so on. The Audio file module 304 contains the audio file formats such as, but not limited to, MP3, OGG, FLAC, and so on. In an embodiment, the Book/package server 102 contains various video files that are available in the market. The Book/package server 102 also contains information about stop points, GIF animation links, play button links and play button position. The GIF animation links may contain the information about the GIF animations of all scenes of e-books available in the market.

The plurality of Java program files 306 make use of certain in-built android libraries, open source animation libraries and open source openGL libraries for high end animations and graphics.

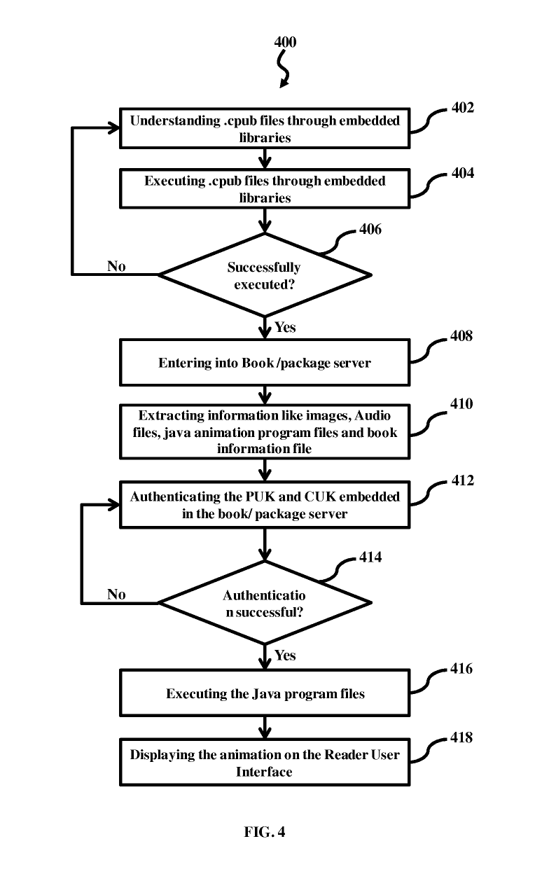

FIG. 4 is a flow diagram depicting a method 400 for providing movie experience while reading an e-book by using the Interactive media reader/viewer system 100 having the an Interactive Media reader/viewer, according to the embodiments as disclosed herein. At step 402, the method 400 includes understanding the .cpub files through the embedded files associated with the Media reader/viewer 106. Further, at step 404, the .cpub files are executed by the Extraction and execution module 214 of the Media reader/viewer 106. Initially, the Media reader/viewer 106 receives a User request to read or download an e-book through the Interactive media player application installed in the User electronic device 108. At step 406, the Media reader/viewer 106 checks whether the .cpub files are successfully executed by the Extraction and execution module 214. Upon successful execution of the files, the Extraction and execution module 214 enters the Book/package sever 102 through the Network 104.

At step 410, the Extraction and execution module 214 extracts the information like images, Audio files, java animation program files and book information file from the Book/package server 102.

At step 412, the PUK/CUK authenticator 204 authenticates the PUK and CUK information embedded in the Book/package server 102. At step 414, the PUK/CUK authenticator 204 checks whether the authentication is done successful by checking the PUK and CUK details. At step 414, if the verification is considered successful, the Extraction and execution module 214 executes the java program files from the Book/package server 102. For example, the information such as, but not limited to, data file stop points, GIF animation links, play button links and play button position and so on are read. In an embodiment, the execution includes extracting all stop point information, GIF animation links and play button links associated with the data.

At step 414, if the authentication is unsuccessful the Media reader/viewer 106 goes to step 412. Further, the GIF animations, graphics and photos are integrated into a scene menu grid of the Reader UI 202.

Later, at step 418, the created animation is displayed to the User through the Reader UI 202. For example, the Reader UI 202 displays the play button specified by the Data file on the screen of the User electronic device 108 in order to play the video. In an embodiment, the play button is specified at the exact play button position specified by the Data file. The Reader UI 202 checks whether the user selects the play button displayed on the screen of the User electronic device 108. For example, the user can touch the play button displayed if his/her User interface permits. In other example, the Media reader/viewer 106 allows the user to selects the play option by pressing menu button or OK button associated with the User electronic device 108. If the user selects the play button, the Media reader/viewer 106 continues to play the video to the User.

The various actions in method 400 may be performed in the order presented, in a different order or simultaneously. Further, in some embodiments, some actions listed in FIG. 4 may be omitted. Data files comprise multiple information like animation parameters, audio parameters and scene parameters for the final pixel data package. The application positions, plays and performs functions on the pixel data package according to the parameters held in the data files.

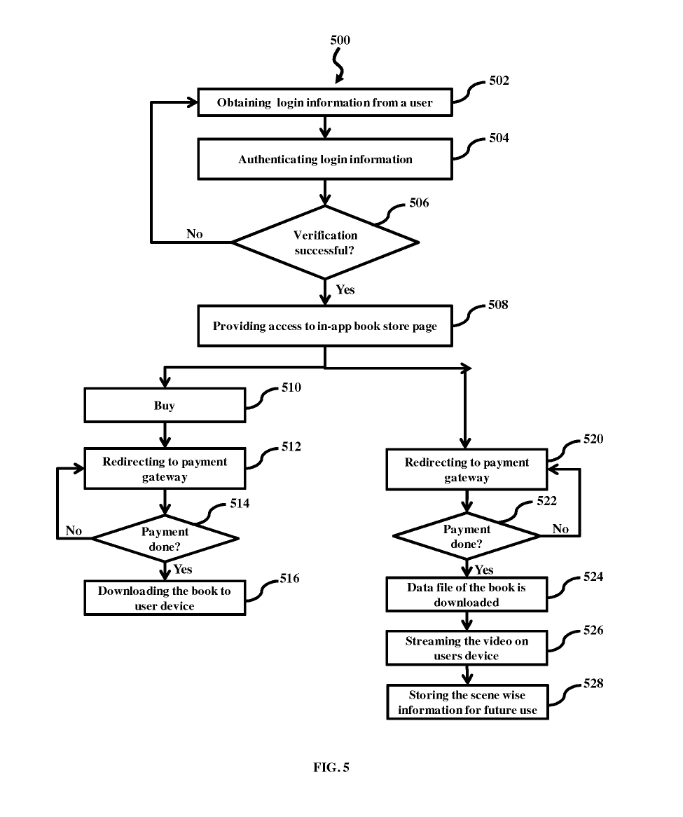

FIG. 5 is a flow diagram illustrating a method 500 of User interaction associated with the Interactive media reader/viewer system 100, according to the embodiments as disclosed herein.

At step 502, log in information and other desired credentials are obtained from a user. The log in information and the desired credentials are stored in the Media player engine 106. As such the User (CUK) and book (PUK) information engine 208comprises details and other secure information of all the users who have registered or logged on the website of the present invention.

At step 504, log in information is authenticated. Authentication is the process of confirming the identity of a user. Authentication can include but not be limited to HTTP basic authentication, Form-based login authentication, client certificate authentication, mutual authentication and digest authentication.

At step 506, a check is performed to ascertain if verification was successful. The PUK/CUK authenticator 204 checks whether the authentication is done successful by checking the login details along with the PUK and CUK details. If verification is considered successful, access is provided to app book store page at step 308. In case verification is not successful, correct login information is required to be obtained from the user.

If a user does not have an account, he/she can select the ‘Register’ option to create a new account. The user, having previously signed up, and generated a log-in name and password, can enter the application and begin viewing the e-book store page. In an embodiment, if a user forgot the password, an option labeled “Forgot Password” can be accessed. Once accessed, the Interactive Media reader/viewer system 100 will determine the identity of the user, and may forward the sign-in information to the user. This information can be transmitted by a method including, but not limited to, e-mail, texting, and messages to a social networking sites.

After entering to the app book store the user can either download the e-books available or the user can select OTE through which the user can read desired portion of the e-book once. If the user initiates to buy the e-book, at step 512, the user is redirected to payment gate way. Further, the user can make the payment via net banking or through credit or debit card information. Once the payment is done at step 514, the selected book is downloaded onto the User electronic device 108 and is reflected in the ‘my books’ section of the application.

If the user initiates OTE transaction to view the book once, at step 520, the user is redirected to the payment gate way. Further, the user can make the payment via net banking or through credit or debit card information. Once the payment is done at step 522, the data file of the selected book is downloaded to the User electronic device 108.

The various actions in method 500 may be performed in the order presented, in a different order or simultaneously. Further, in some embodiments, some actions listed in FIG. 5 may be omitted.

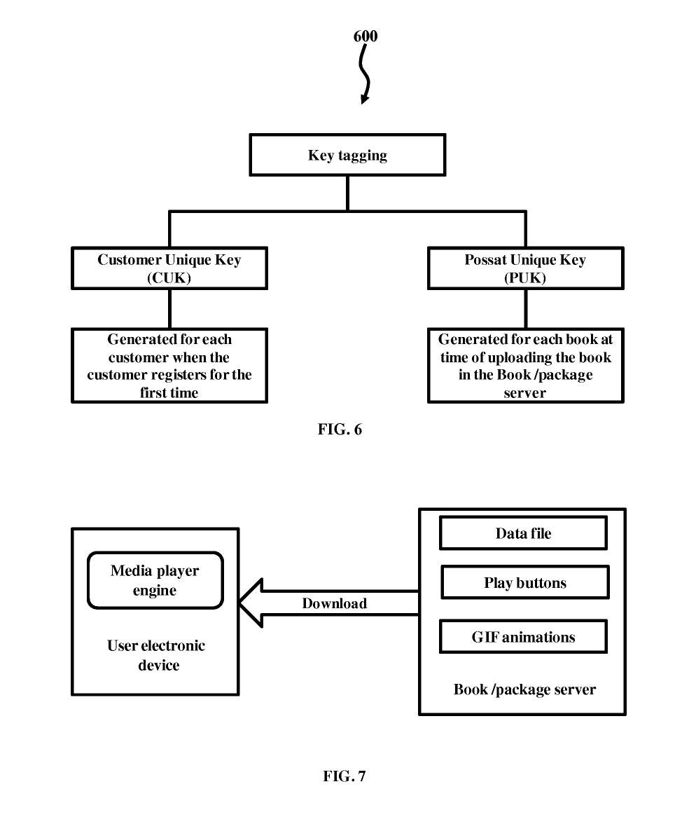

FIG. 6 is a block diagram illustrates various key tagging mechanisms associated with the Interactive media reader/viewer system 100 to secure data sharing and authentication, according to the embodiments as disclosed herein. The Interactive media reader/viewer system 100 uses various keys to secure data sharing and authentication. The java programmed files makes use of various libraries for validating user's identity while accessing an e-book or comic book from the Book/package server 102. The CUK is generated for each user when the user is registered with the application for the first time. When any Book is uploaded on to the Book package server 102, each book contains another unique key called PUK. PUK is the authentication that this particular book is authorized to be sold on the In-App book store for the Users.

In an embodiment, when a new book is uploaded onto the Book package server 102, the Media player engine 106 initially checks for the PUK for authentication. If the PUK is authenticated successfully, then the book is reflected on the In-App book store and is further available for purchase. In an embodiment, if a user purchases the book from the In-App book store, then the user's CUK is also added to the Book's data file and downloaded to the User's electronic device 108.

By adding the CUK into the Book's Data file, the file downloaded can only be opened if the User who purchased the book is logged in to the application. For example, if a user X purchase a book on the In-App book store, the CUK of user X is added to the Books' data file while the book is downloaded onto User X's electronic device. Now, if the user X logs out and user Y logs in to Interactive media reader/viewer system 100 using the same device, user Y will not be able to view the book as the CUK in the Book file is dedicated to user X and to not user Y. Also, if user X shares his book to user Y's electronic device via Bluetooth or Wi-Fi, the Book will not open in user Y's device as the book contains user X's CUK.

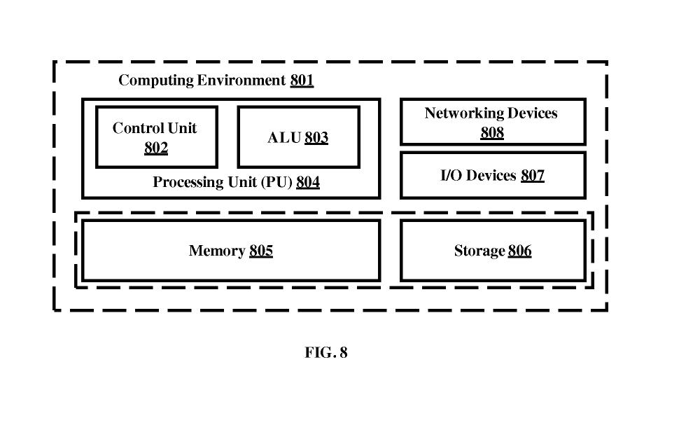

FIG. 7 depicts an exemplary block diagram illustrating User interaction with the Interactive media reader/viewer system 100 while downloading an e-book or comic book, according to embodiments as disclosed herein. As depicted in the FIG. 7, the selected book is downloaded from the Book package server 102 through the network 104.

### Explanation of the Execution of the Program Software Code

It will be understood that elements described in the abstract as “App Engine,” “Stream Processing Engine,” and so forth, may be implemented in hardware or software, as a general purpose computer system having software program code for implementing the functionality described herein through operation of the computer system as it executes the program software code.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 1802.11n). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

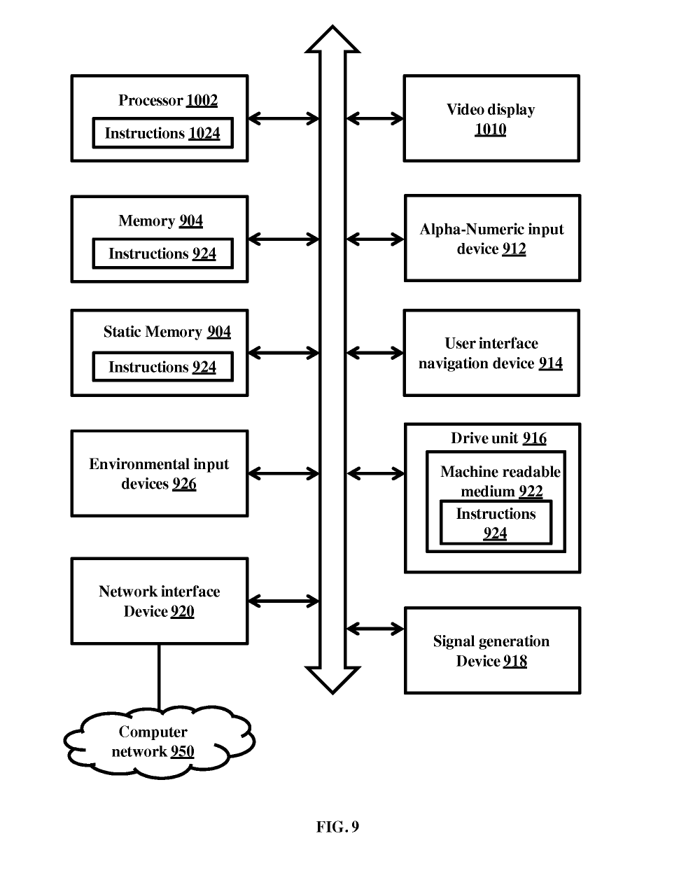

FIG. 8 illustrates a computing environment implementing the application, according to embodiments disclosed herein. As depicted the computing environment comprises at least one processing unit that is equipped with a control unit 802 and an Arithmetic Logic Unit (ALU) 803, a memory 805, a storage unit 806, plurality of networking devices 808, and a plurality Input output (I/O) devices 807. The processing unit 804 is responsible for processing the instructions of the algorithm. The processing unit 804 receives commands from the control unit 802 in order to perform its processing. Further, any logical and arithmetic operations involved in the execution of the instructions are computed with the help of the ALU 803.

The overall computing environment can be composed of multiple homogeneous and/or heterogeneous cores, multiple CPUs of different kinds, special media and other accelerators. The processing unit 804 is responsible for processing the instructions of the algorithm. The processing unit 804 receives commands from the control unit 802 in order to perform its processing. Further, any logical and arithmetic operations involved in the execution of the instructions are computed with the help of the ALU 803. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit.

In case of any hardware implementations various networking devices or external I/O 807 devices may be connected to the computing environment to support the implementation through the networking unit and the I/O device unit.

### Exemplary System Architecture

FIG. 9 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920. The computer system 900 may also include a environmental input device 926 that may provide a number of inputs describing the environment in which the computer system 900 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 924 may further be transmitted or received over a computer network 950 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations thereof. Example embodiments may be implemented using a computer program product (e.g., a computer program tangibly embodied in an information carrier in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communications network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. A client and server are generally remote from each other and typically interact through a communication network. The relationship of client and server arises by virtue of computer programs runningon their respective computers and having a client-server relationship to each other. In embodiments deploying a programmable computing system, it will be appreciated that both hardware and software architectures may be considered.

Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

The embodiments disclosed herein can be implemented through at least one software program running on at least one hardware device and performing network management functions to control the elements. The elements shown in FIG. 1 to FIG. 3 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-6. (canceled)

7. An interactive real time media apparatus configured for generating at least one animated displayable edited pixel data package and pixel data packages with a pre-defined amount of audio integration from an original pixel data package or pixel data packages where in at least one pixel from each of the individual pixel data package or pixel data packages are extracted to form an individual pixel data package of the finished interactive, displayable edited pixel data package coupled with said audio integration, said apparatus comprising:
a pixel data capture device configured for capturing an original pixel data package;
a pixel data display device configured for displaying final pixel data packages;
a data entry device operably coupled with said pixel data capture device and operated by a user to select at least one pixel from said individual pixel data package to create multiple interactive animated pixel data packages by including parameters for said individual pixel data packages, wherein said data entry device is selected from a group of devices consisting of: a keyboard, a display, a wireless communication capability device, and an external memory device;
an audio editing capability device configured to record, edit, and compose audio components;
an archiving capability device configured to package the final pixel data packages, audio components, and data files; and
a digital processing unit operably coupled with said data entry device, audio editing device, and archiving device, said digital processing unit is configured for:
identifying the selected at least one pixel from said original pixel data package;
extracting the identified at least one pixel as a finished pixel data package;
extracting audio components and audio packages;
coupling audio components to the said final pixel data packages;
extracting the data entry output files; and
archiving said final pixel data packages, audio components, data files.

8. The apparatus of claim 1, wherein said digital processing unit is further configured for:
computing motion vectors associated with individual final pixel data packages; and
applying said motion vectors for said individual pixel data packages.

9. The apparatus of claim 8, further comprising interactive book format objects comprising at least one of: a Library Object, Book List Object, table of contents Object, Title Pages Object, Chapter Object, Page Object, Paragraph List Object, Paragraph Object, Formatting Object, and User Notes Object.

10. The apparatus of claim 9, further comprising additional content comprising at least one of: formatting information, historical data, geographical data, biographical data, concordance, at least one image, at least one map, at least one sound, and at least one animation.

11. The apparatus of claim 1, further comprising means for providing published electronic content to a reader by at least one of: downloading the content from an Internet website or loading the published electronic content from a portable storage device that is physically inserted into an electronic reading system or a host computer of a reader

12. A apparatus of claim 1, further comprising:
means for allowing one or more users to download final archives;
means for extracting at least one of the final pixel data packages, audio components, and data files; and
means for displaying the pixel data packages and enabling playing of audio components as specified in said data files.
